(19) United States
(12) Patent Application Publication
(10) Pub. No.: US 2005/0216389 A1
(43) Pub. Date: Sep. 29, 2005

(54) Online accounting system and method

(75) Inventor: Chun Yu Leung, Wanchai (HK)

Correspondence Address: LEYDIG VOIT & MAYER, LTD, 700 THIRTEENTH ST. NW, SUITE 300, WASHINGTON, DC, 20005-3960, US

(73) Assignee: Hong Kong Internet Accounting Limited, Wanchai (HK)

(21) Appl. No.: 11/087,559

(22) Filed: Mar. 24, 2005

(30) Foreign Application Priority Data
Mar. 29, 2004 (CN) 200410029631.2

(51) Int. Cl. G06F 17/60

(52) U.S. Cl. 705/35; 705/30

(57) ABSTRACT

An online accounting system for use over the Internet sets up an account and a user, and assigns an account number and a user name with corresponding passwords. The account a number of account items. Rights for operating some or all of the account items are assigned to the user, for initializing an operation by the user, for selecting a path for the operation, and for processing the operation. The system also includes an online accounting method.

### BACKGROUND OF THE INVENTION

The present invention relates to an online accounting system and method for use over an existing computer or electronic network, and in particular but not exclusively the Internet, which provide different rights of access and operation capabilities to different users.

### DESCRIPTION OF PRIOR ART

With the wide spreading of the Internet, it is desired to use such a vast computer network to reduce operating costs in various industries. Moreover, nowadays, the offices and branches are spread around, and thus the centralization of management in finance and accounting is very important. On the other hand, the managers wish to clearly know the financial state of the company wherever they are so as to make appropriate decisions. However, the existing finance software system is generally used on a single computer or used on a local area network within the company, and the costs of use and maintenance are high, and data are liable to loss. Moreover, after entering an existing typical accounting system, either all the items could be retrieved and operated or a password is required for accessing each item of level of items. The former lacks security or control and in particular is unable to differentiate users, whereas the latter requires multiple passwords that are inconvenient even if one can memorize them all.

### SUMMARY OF THE INVENTION

According to a first aspect of the invention, there is provided an online accounting system for use over an electronic network, comprising:
means for setting up an account, including assigning an account identifier and a corresponding password, the account including a plurality of account items;
means for setting up a user of the account, including assigning a user identifier and a corresponding password within the account;
means for assigning rights of operating some or all of the account items to the user within the account;
means for initializing an operation by a user identified by the user identifier;
means for selecting a path for said operation by the user; and
means for processing said operation of the user.

Preferably, the online accounting system includes means for processing a request for user identifier and password, and means for processing the user identifier.

Preferably, the online accounting system includes a secure account database interface for allowing operations to the account.

Preferably, the online accounting system includes means for storing the user and the account as an associated user.

Preferably, the user identifier is associated with information of a selected path for directly sending via said electronic network accounting data to the account among a plurality of other said accounts in the system, and is associated with at least one operable account item within the account.

Preferably, said means for processing said user's operation comprises:
means for verifying that an input user identifier is valid and then verifying that an input password coincides with the password corresponding to the user identifier; and
means for identifying proper details of the user.

Preferably, said means for processing said user's operation comprises:
means for determining how to implement operations of the user and acquiring an identifier for the account; and
means for sending operation information for performing the operations via said electronic network.

In a preferred embodiment, the online accounting system includes a plurality of predetermined categories for specifying the account items primarily according to their nature.

More preferably, the online accounting system further includes displaying means for displaying the account items of at least some of the categories for selection by the user.

Further more preferably, said displaying means comprises a pull-down menu on a computer screen.

More preferably, the online accounting system further includes classifying means for automatically classifying the account items among a plurality of predetermined types according to the categories specified for the account items.

Further more preferably, the types comprise sales, purchases, expenses and all other transactions.

According to a second aspect of the invention, there is provided an online accounting method for use over an electronic network, comprising:
setting up an account, including assigning an account identifier and a corresponding password, the account including a plurality of account items;
setting up a user, including assigning a user identifier and a corresponding password within the account;
assigning rights of operating some or all of the account items to the user identifier within the account;
initializing an operation by a user identified by the user identifier;
selecting a path for said operation by the user; and
processing said operation of the user.

Preferably, the online accounting method includes:
processing a request for user identifier and password; and
storing the user identifier and password and the account as an associated account.

Preferably, the online accounting method includes:
verifying that an input user identifier is valid and then verifying that an input password coincides with the password corresponding to user identifier; and
identifying proper details of the user.

In a preferred embodiment, the online accounting method includes providing a plurality of predetermined categories for specifying the account items primarily according to their nature.

More preferably, the online accounting method further includes displaying the account items of at least some of the categories for selection by the user.

More preferably, the online accounting method further includes providing a pull-down menu on a computer screen for displaying at least some of the categories for selection by the user.

More preferably, the online accounting method further includes automatically classifying the account items among a plurality of predetermined types according to the categories specified for the account items.

Further more preferably, the types comprise sales, purchases, expenses and all other transactions.

### BRIEF DESCRIPTION OF DRAWINGS

The invention will now be more particularly described, by way of example only, with reference to the accompanying drawings, in which:

FIG. 1 is a schematic functional block diagram of an embodiment of an online accounting system in accordance with the invention;

FIG. 2 is a schematic operational flowchart of an online accounting method embodying the invention for the accounting system of FIG. 1;

FIG. 3 is a schematic block diagram depicting an example of use of the subject accounting system/method in a corporate environment;

FIG. 4 is a table of account items for the subject accounting system/method;

FIG. 5 is a table specifying legends used in the table of FIG. 4; and

FIGS. 6 to 11 are similar diagrams showing a webpage on a computer screen for the subject accounting system/method.

### DETAILED DESCRIPTION OF PREFERRED EMBODIMENT

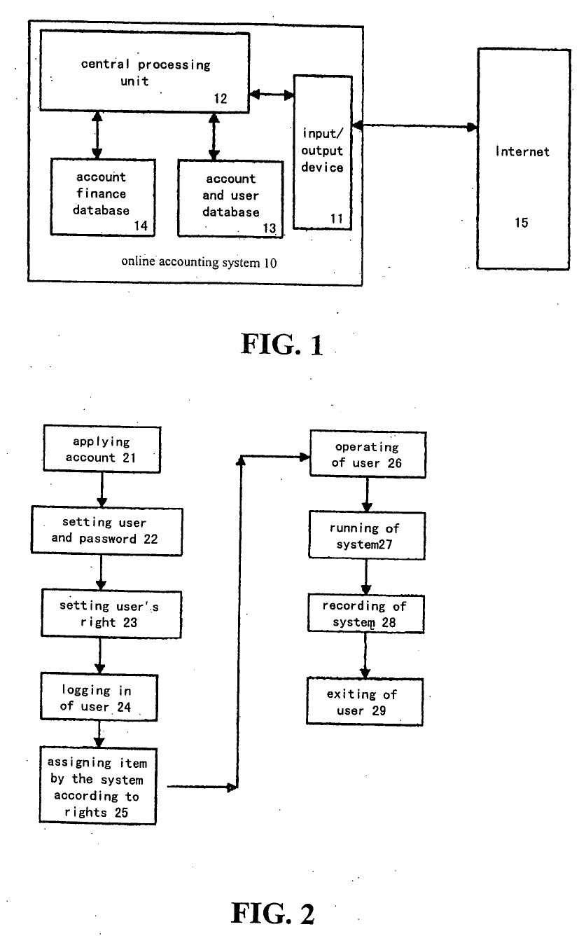

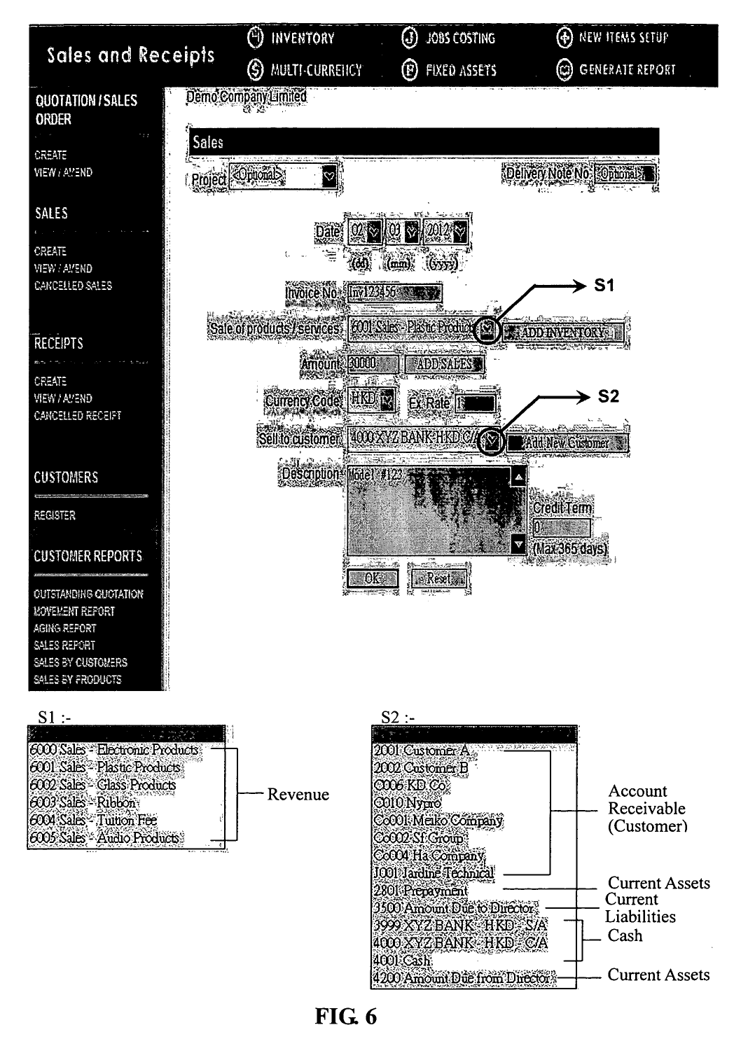

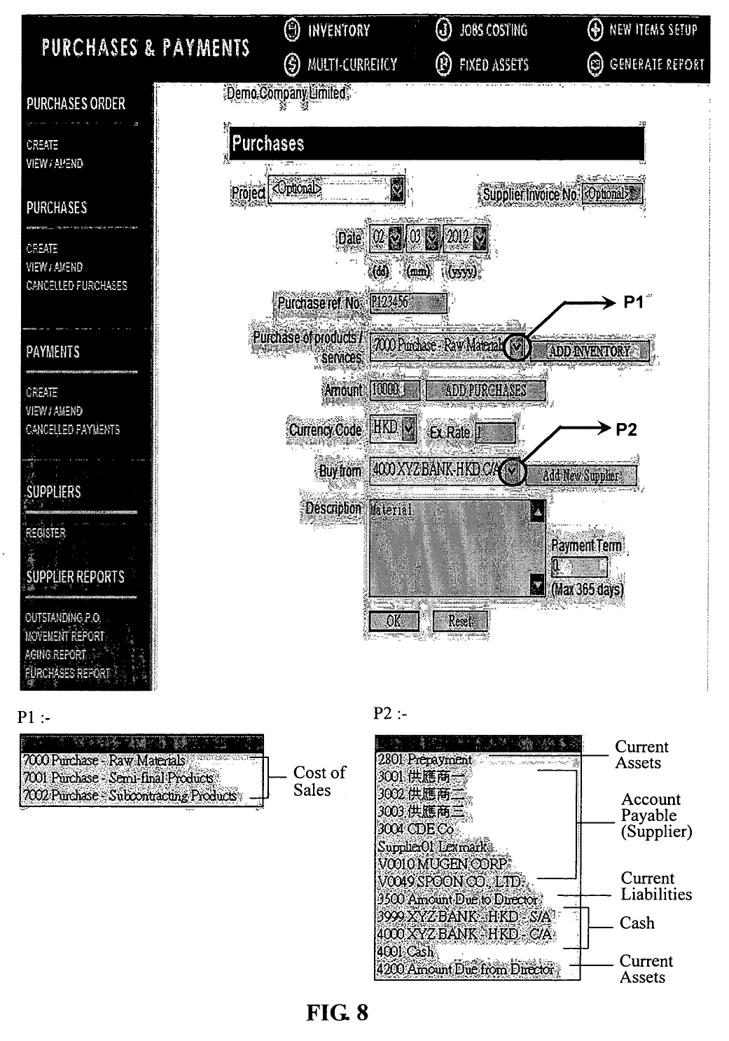

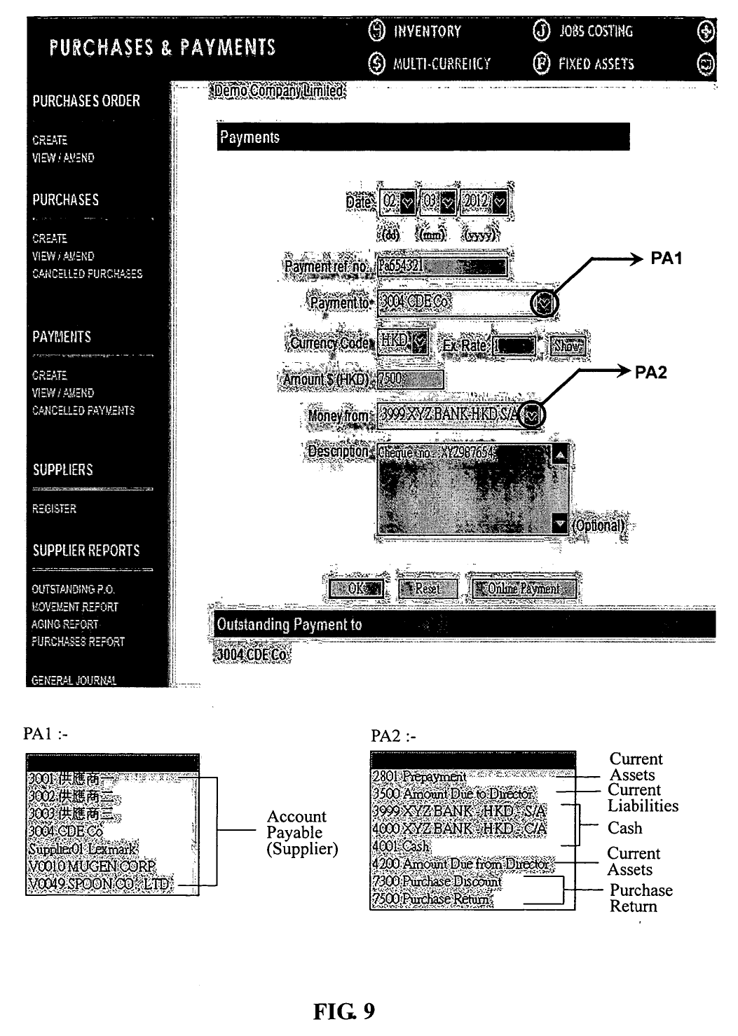

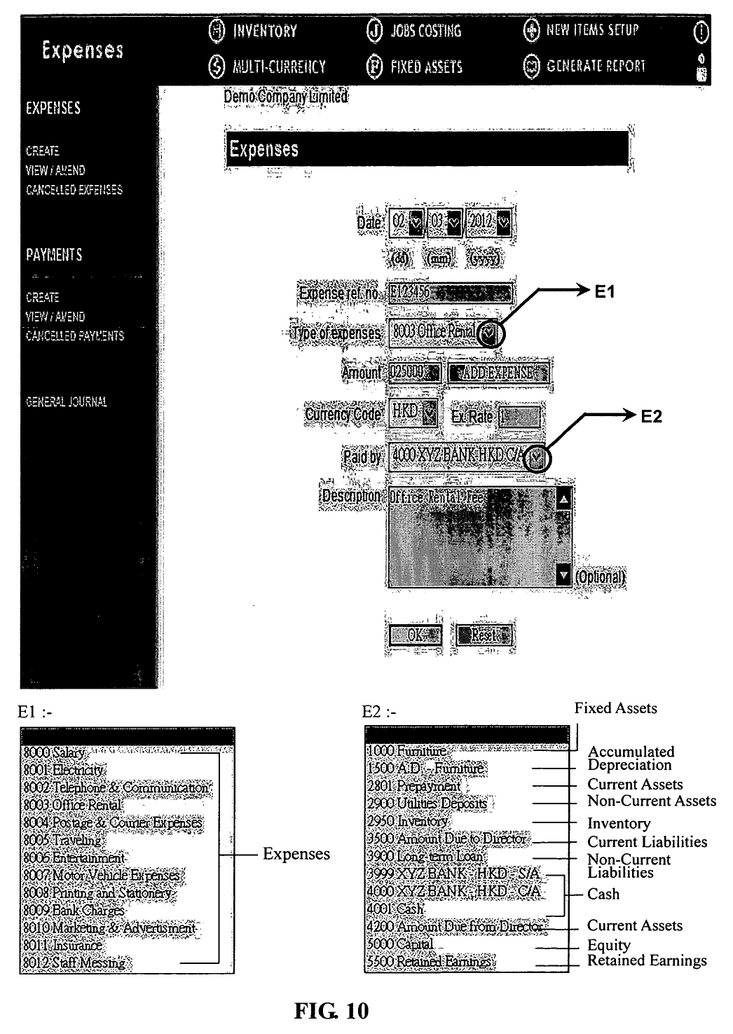

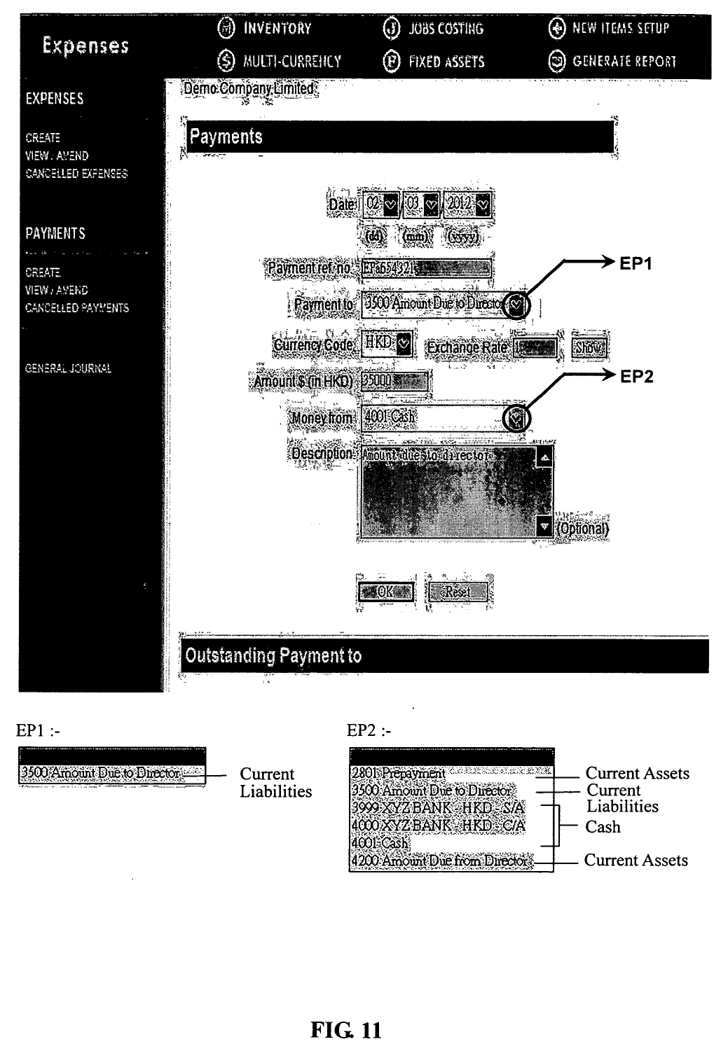

Referring to the drawings, there is shown an online accounting system for performing an online accounting method, embodying the invention for use over a LAN or WAN network connected to the Internet 15. The account system 10 is implemented by way of a server with supporting resources, comprising a central processing unit 12, an account finance database 14, an account and user database 13 with a secure interface for allowing users' operations on accounts, and an input/output device 11 connected via the Internet 15 to the users' computers or the like (FIG. 1). The system server hosts a website for online visit by users, which provides a webpage (FIGS. 6 to 11) for the users to operate and make use of the accounting system/method.

In operation, the central processing unit 12 will accept and process an account application upon request by a company for example, by inter alia setting up the account database 14 corresponding to the account and storing the account and an address path selected therefor to the account and user database 13 (step 21). The company account is identified by way of a unique account number (and/or name for ease of recall). As part of the procedures of opening an account with the system, a first user acting as a system administrator should first be set up as identified by a specific user name (identifier) and corresponding password (PIN) assigned thereto.

The administrator has the authority to, upon logging in the company account, add and set up other users and their corresponding passwords under the same account (step 22). According to different categories of the users, for example based on their seniority and/or responsibilities, the administrator is to set and assign to them the rights of access and privileges of operating various financial items under the account (step 23), and such rights and privileges are stored in the account and user database 13. Thus, each user is associated with at least one operable account item within the account.

All the users, including the administrator, are registered by their user names and passwords with the company account. Each user is stored with the account in the account and user database 13 as an associated user, and the user name and password and the account are stored as associated account. Each user name is associated with information relating to the said selected address path leading, via the Internet, to the company account stored in the account and user database 13 for directly sending accounting data to that account among a number of other accounts for different companies also set up in the system.

To initialize accounting operations, a user should visit the system website and then enter his/her user name and corresponding password to request log-on to the accounting system and the account number to access the company account (step 24). Upon receiving the log-on request, the central processing unit 12 will first compare the entered user name and company account number with data retrieved from the account and user database 13 to verify whether the user name is valid in respect of the company account identified. If this is the case, the central processing unit 12 will then verify whether the entered password coincides with the password associated with that user name. Proper details of the user will then be identified when verification is successful, whereupon the accessible and operable financial items will be provided and made available to the user according to the user's rights and privileges (step 25).

After the user has retrieved and operated the desired financial items (step 26), the central processing unit 12 will, upon receiving the user's instructions and related data or information via the Internet, determine how to implement and then implement the relevant operations as instructed and then output the results of operations to the user (step 27). The items and contents which are operated and accessed by the user together with the related time will be recorded in the account finance database 14 (step 28). The user may log off the system when operations are finished (step 29).

With the use of the aforesaid online accounting system and method, different users can perform different financial operations within the scope of their respective predefined rights and privileges, and their operations are recorded in the database for periodical backup, so that the finance of the company can be managed and maintained in a secure manner. Furthermore, there is no restriction on the location from where access can be made, and it is only necessary to log onto the accounting system via the Internet to carry out financial operations, whereby the system can be accessed and used conveniently and easily.

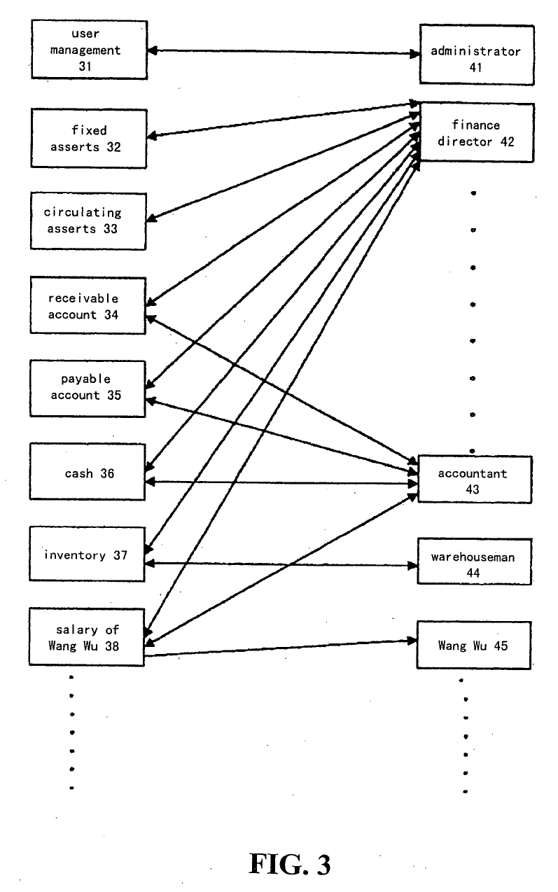

FIG. 3 depicts an example of the use of the subject online accounting system in a corporate environment. A system administrator 41 can retrieve and operate user management items 31 for system operation. A financial director 42 can retrieve and operate all types of financial information available in the system as shown. According to the scope of his/her duties and responsibilities, an accountant 43 can retrieve and operate receivable accounts 34, payable accounts 35, cash 36 and inventory 37, etc., and can process payroll information or the like such as the salary of an employee named Wang Wu 38. On the contrary, the employee Wang Wu 45 can only review information relating to his own salary 38. As a further user, a warehouseman 44 can only gain access to inventory information 37 by nature of his task.

Thus, the various members of the company are able to perform operations according to their duties and responsibilities. Thus, the financial director can implement most business operations in order to, for example, run the company and ascertain its financial status at any time and from anywhere, whereas junior staff can only retrieve their own salary data for example, without the exposure to or risk of leaking confidential financial information of the company.

With access by users based on preset usernames and passwords that are pre-assigned with specific capabilities and functions, the subject online accounting system (method) is provided with external protection against unauthorized access by third parties and an internal hierarchical structure that suits the various level of secrecy within an organization.

To enhance the ease of use of the subject accounting system and method by users, especially for those who are not familiar with the basic principles of accounting, the company accounts are created with customized account items (including account codes and descriptions) of specific Account Natures (Categories) that are built into the accounting system during system setup. Such account items must first be created in the user's company account before the system or its various accounting tools and programs can be used and run.

The accounting system will automatically identify and classify each account item, according to the specified Account Nature (Category), among a set of four (for example) predetermined general types or Core Sections of Sales, Purchase, Expenses and All Other Transactions. This offers the users easy identification and rapid exploration and selection of specific account items in carrying out financial transactions such as data entry and processing, without exposure to an excessive amount of account items that are irrelevant to the specific operations in progress.

More specially, the accounting system is built to classify such account items, based on their specific account natures, into predetermined Core Sections of Sales, Purchase, Expenses and All Other Transactions. For example, those account items of the nature of Revenue are arranged or grouped in a Sales section for selection as Sales parameter while specific data are being inputted during operation of a Sales transaction.

There is a set of sixteen Categories (Account Natures) which are predefined in/by the subject accounting system/method as follows, being various specific natures primarily by which all account items are to be specified:

(1) Non-Current Assets

These assets that are fixed i.e. not in current status, and cannot freely flow in cash in the short run and could be kept over years in the long run.

Examples: Investment in securities and investment in subsidiaries, etc.

(2) Fixed Assets

These assets that comprises anything which a business owns or buys for use within the business and which still retains a value at year end. These account items usually include major items like land, buildings, equipment and vehicles but can include smaller items such as tools.

Examples: Computer equipment, furniture and fixtures, etc.

(3) Accumulated Depreciation

These account items include the depreciation of a fixed asset until the end of the asset's useful life (either because it has been scrapped or sold). It is credited each year with that year's depreciation, hence the balance increases (i.e. accumulates) over a period of time. Each fixed asset will have its own accumulated depreciation account.

Examples: Accumulated depreciation of computer equipment, accumulated depreciation of furniture and fixtures, etc.

(4) Current Assets

These assets include money in the bank, petty cash, money received but not yet banked (i.e. cash in hand), money owed to the business by its customers, raw materials for manufacturing, and stock bought for re-sale. These account items are termed ‘current’ because they are active accounts. Money flows in and out of these items regularly each financial year, and frequent reports of their balances will be needed if the business is to survive.

Examples: Prepayment and sundry debtors, etc.

(5) Non-Current Liabilities

These account items usually refer to long term loans, or loans which last for more than one year or so.

Examples: Bank loan and hire purchase loan, etc.

(6) Equity

This Category represents the value of the business to the owner of the business.

Examples: Share capital and general reserves, etc.

(7) Revenue

These account items include the sales and any other taxable income of the business.

Examples: Sales of finished goods and consultation fee derived, etc.

(8) Cash

This Category is used to show the current total of money received (i.e. not yet banked or spent). The amount may include money, cheques, credit card payments and bankers drafts, etc.

Examples: Cash at bank and cash in hand, etc.

(9) Inventory

This Category is used to record the details of individual items of stock. Inventories can also be used to hold the details of other assets of the business.

Examples: Inventory for finished goods and inventory for raw materials, etc.

(10) Current Liabilities

These account items include bank overdrafts, short term loans (e.g. less than a year), and what the business owes its suppliers. They are termed ‘current’ because they are active accounts. Money flows in and out of these items each financial year, and frequent reports of their balances will be needed if the business is to survive.

Examples: Accrued expenses and sundry creditors, etc.

(11) Other Income

This Category corresponds to income that is derived out of principle activities of business.

Examples: Bank interest income and claim for insurance compensation, etc.

(12) Cost of Sales

This Category stands for a formula for working out the direct costs of sales (including stock) over a particular period, and the result represents the gross profit. The formula is ‘opening stock’+‘purchases’+‘direct expenses’−‘closing stock’.

Examples: Purchases and wages for workers, etc.

(13) Expenses

This Category relates to goods or services that are purchased directly for the running of the business, and does not include goods bought for re-sale or any items of a capital nature.

Examples: Rental expenses and salary, etc.

(14) Sales Return (Discount)

The Category ‘Sales Return’ caters for goods that have been sold to customers and are now returned to the company due to, for example, goods defect or false orders. The compensation of ‘Sales Return’ may be in the form of money back or delivery of new goods. The Category ‘Sales Discount’ allows for goods that are sold to customers at discounted prices due to, for example, preferential goods relationship with customers or large value of stock sold.

Examples: Sales return and sales discounted, etc.

(15) Purchase Return (Discount)

The Category ‘Purchases Return’ caters for goods that have been purchased from suppliers and are now returned from the company due to, for example, goods defect or false orders. The compensation of ‘Purchases Return’ may be in the form of money back or delivery of new goods.

The Category ‘Purchases Discount’ allows for goods that have been purchased to suppliers at discounted prices due to, for example, preferential goods relationship with suppliers or large value of stock purchased.

Examples: Purchases return and purchases discounted, etc.

(16) Bad Debt

This Category represents the value of unrecoverable debts from customers. Real bad debts or those that are likely to happen may be deducted as expenses against tax liability provided that they refer specifically to a customer.

Example: Bad debt and general provision, etc.

Each account items is identified by or associated with three fields in the accounting system, namely Account Codes, Account Descriptions and Account Natures. All these fields should be completed or specified in order to enter an account item.

The first two fields (Account Code and Account Description), have no specific formats and are intended to be filled out by the users in accordance with the internal practice of their own company, whereas the third field (Account Nature) must be selected from a predetermined list of choices. As an example, the users may enter ‘1’ in the Account Code field and ‘Computer Equipment’ in the Account Description field, or ‘1000’ as the Account Code and ‘Computer System’ as the Account Description, but the Account Nature should be chosen as Fixed Assets for example.

Thus, for each account item, whatever setting or content of the Account Code and the Account Description may be, the Account Nature must be chosen from at least some of the list of the sixteen Categories mentioned above. The account items, after they have been assigned with specified account natures, will be allocated to the relevant Core Sections, as set forth below, for easy access and processing.

| Core | | |
|---|---|---|
| Sections | Account Fields | Account Natures |
| Sales | Sale of products/ | Revenue |
| | services | |
| | Sell to customer | Current Assets |
| | | Cash |
| | | Current Liabilities |
| Receipt | Receive from | Customer |
| (under | Money go to | Bad Debt |
| Sales) | | Current Assets |
| | | Cash |
| | | Current Liabilities |
| | | Sales Return(Discount) |
| Purchases | Purchase of | Cost of Sales |
| | products/services | |
| | Buy from | Current Assets |
| | | Cash |
| | | Current Liabilities |
| Payment | Payment to | Supplier |
| (under | Money from | Current Assets |
| Purchases) | | Cash |
| | | Current Liabilities |
| | | Purchase Return(Discount) |
| Expenses | Type of expenses | Expenses |
| | Paid by | Non-Current Assets |
| | | Fixed Assets |
| | | Accumulated Depreciation |
| | | Current Assets |
| | | Non-Current Liabilities |
| | | Equity |
| | | Cash |
| | | Inventory |
| | | Current Liabilities |
| Payment | Payment to | Current Liabilities |
| (under | Money from | Current Assets |
| Expenses) | | Cash |
| | | Current Liabilities |
| All other | Account- | Non-Current Assets |
| Transactions | In/Additions | Fixed Assets |
| | | Accumulated Depreciation |
| | | Current Assets |
| | | Non-Current Liabilities |
| | | Equity |
| | | Revenue |
| | | Cash |
| | | Inventory |
| | | Current Liabilities |
| | | Other Income |
| | | Cost of Sales |
| | | Expenses |
| | | Sales Return(Discount) |
| | | Purchase Return(Discount) |
| | | Bad Debt |
| | Account- | Non-Current Assets |
| | Out/Disposal | Fixed Assets |
| | | Accumulated Depreciation |
| | | Current Assets |
| | | Non-Current Liabilities |
| | | Equity |
| | | Revenue |
| | | Cash |
| | | Inventory |
| | | Current Liabilities |
| | | Other Income |
| | | Cost of Sales |
| | | Expenses |
| | | Sales Return(Discount) |
| | | Purchase Return(Discount) |
| | | Bad Debt |

According to this classification scheme of the subject accounting system and method, the Account Natures (specific categories) and the Core Sections (general types) are pre-defined and hard-coded in the system programs, which form the basis of classifying account items. Users are confined to select these Account Natures for their account items created in their company account, which will then be automatically classified into the Core Sections.

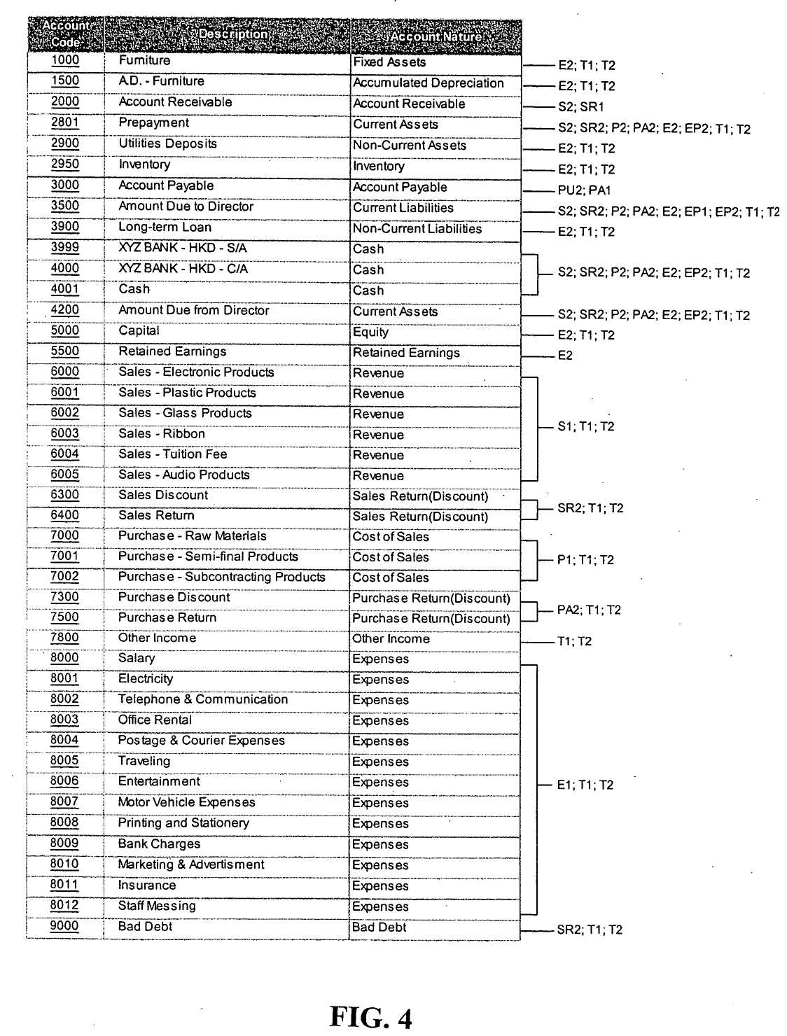

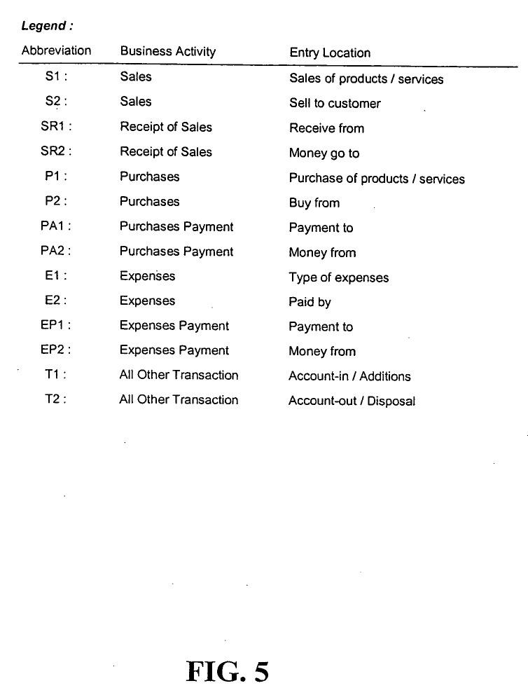

FIGS. 4 to 11 illustrate an example of a specific company account created by the subject accounting system/method and how certain account items are entered on-screen. Some of the account items are listed in the table of FIG. 4, with their business activities and entry locations on the webpages (examples only) of FIGS. 6 to 11 indicated by legends using abbreviations appearing on the right side of the table, said abbreviations being specified in FIG. 5.

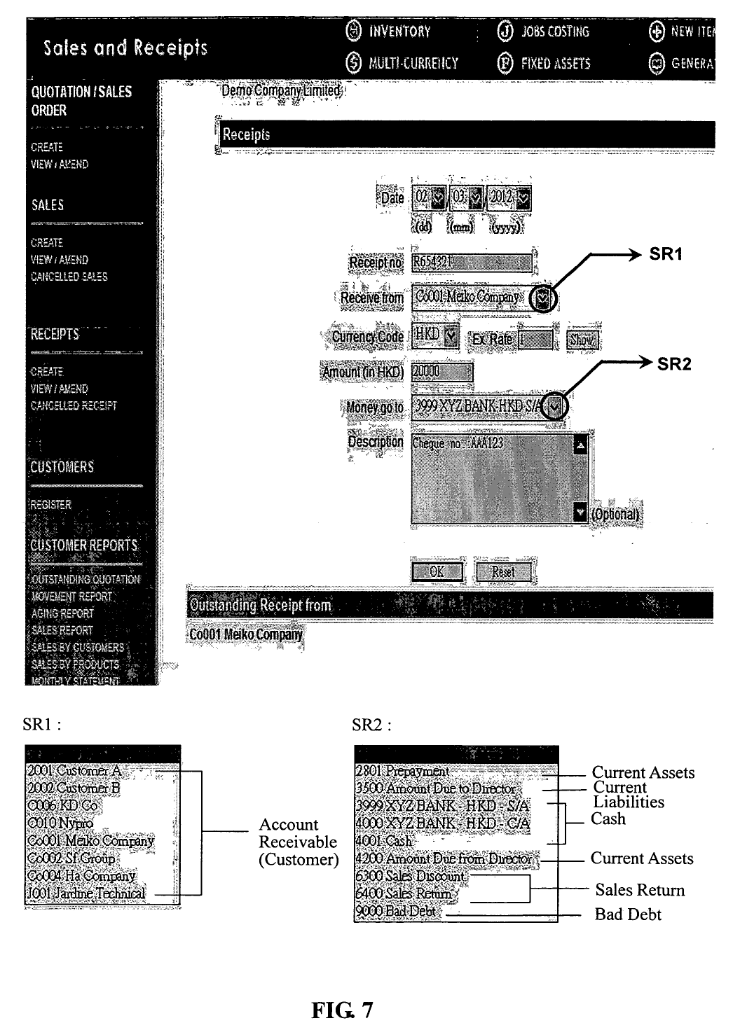

The accounting system is accessed via the Internet online and is used by way of a computer whose monitor screen displays the system website. The webpages of FIGS. 6 to 11 show up on the screen for entering account data, with each webpage being for account data of one general type i.e. Core Section. The pages of FIGS. 6, 8 and 10 are for Sales, Purchases and Expense data respectively, with those of FIGS. 7, 9 and 11 being for the same types but in the opposite sense i.e. Receipts (under Sales), Payments (under Purchases) and Payments (under Expenses).

In the Sales data entry page (FIG. 6), account item ‘6001 Sales-Plastics Products’ is selected from a pull-down menu S1 for an upper box marked “Sale of products/services”, and account item ‘4000 XYZ BANK-HKD-C/A’ is selected from another pull-down menu S2 for a lower box marked “Sell to customer”. These two account items can be found in the table of FIG. 4. Each item is displayed in the corresponding pull-down menu S1/S2 for choosing amongst certain other items of relevant Account Natures (Categories) that have been classified by the system in the same Core Section i.e. Sales, as indicated by the table in the text above. Thus, the account items in pull-down menu S1 are Revenue items, and those in pull-down menu S2 are of the natures Customer (Account Receivable), Current Assets, Current Liabilities, Cash and Current Assets. The entry pages of FIGS. 7 to 11 share generally the same features as herein described.

In general, while creating account items in their company account, users will have to categorize each account item with a specified Account Nature. The relevant data of the account items, i.e. Account Code, Account Description and Account Nature, will then be saved in a specific table of the account and user database 13. In operation, when users perform transactions in different sections of the system, the system will retrieve the relevant Account Code and Account Description from the database 13 according to the Categories (Account Natures) of the account items and display them in pull-down menus for user selection.

Many of the aforesaid aspects of the accounting system and method can be implemented by using existing computer hardware and software. Those skilled in the art can readily derive purpose-specific programs, codes and code segments to perform the various functions as herein described.

The invention has been given by way of example only, and various modifications of and/or alterations to the described embodiment may be made by persons skilled in the art without departing from the scope of the invention as specified in the appended claims.

1. An online accounting system for use over an electronic network, comprising:
means for setting up an account, including assigning an account identifier and a corresponding password, the account including a plurality of account items;
means for setting up a user of the account, including assigning a user identifier and a corresponding password within the account;
means for assigning rights of operating some or all of the account items to the user within the account;
means for initializing an operation by a user identified by the user identifier;
means for selecting a path for the operation by the user; and
means for processing the operation of the user.

2. The online accounting system as claimed in claim 1, including means for processing a request for user identifier and password, and means for processing the user identifier.

3. The online accounting system as claimed in claim 1, including a secure account database interface for allowing operations to the account.

4. The online accounting system as claimed in claim 1, including means for storing the user and the account as an associated user.

5. The online accounting system as claimed in claim 1, wherein the user identifier is associated with information of a selected path for directly sending, via the electronic network, accounting data to the account among a plurality of other accounts in the system, and is associated with at least one operable account item within the account.

6. The online accounting system as claimed in claim 1, wherein the means for processing the user's operation comprises:
means for verifying that an input user identifier is valid and then verifying that an input password coincides with the password corresponding to the user identifier; and
means for identifying details of the user.

7. The online accounting system as claimed in claim 1, wherein the means for processing the user's operation comprises:
means for determining how to implement operations of the user and acquiring an identifier for the account; and
means for sending operation information for performing the operations via the electronic network.

8. The online accounting system as claimed in claim 1, including a plurality of predetermined categories for specifying the account items according to their nature.

9. The online accounting system as claimed in claim 8, further including displaying means for displaying the account items of at least some of the categories for selection by the user.

10. The online accounting system as claimed in claim 9, wherein the displaying means comprises a pull-down menu on a computer screen.

11. The online accounting system as claimed in claim 8, further including classifying means for automatically classifying the account items among a plurality of predetermined types according to the categories specified for the account items.

12. The online accounting system as claimed in claim 11, wherein the types comprise sales, purchases, expenses and all other transactions.

13. An online accounting method for use over an electronic network, comprising:
setting up an account, including assigning an account identifier and a corresponding password, the account including a plurality of account items;
setting up a user, including assigning a user identifier and a corresponding password within the account;
assigning rights of operating some or all of the account items to the user identifier within the account;
initializing an operation by a user identified by the user identifier;
selecting a path for the operation by the user; and processing the operation of the user.

14. The online accounting method as claimed in claim 13, including:
processing a request for user identifier and password; and
storing the user identifier and password and the account as an associated account.

15. The online accounting method as claimed in claim 13, including:
verifying that an input user identifier is valid and then verifying that an input password coincides with the password corresponding to user identifier; and
identifying details of the user.

16. The online accounting method as claimed in claim 13, including providing a plurality of predetermined categories for specifying the account items according to their nature.

17. The online accounting method as claimed in claim 16, further including displaying the account items of at least some of the categories for selection by the user.

18. The online accounting system as claimed in claim 16, further including providing a pull-down menu on a computer screen for displaying at least some of the categories for selection by the user.

19. The online accounting system as claimed in claim 16, further including automatically classifying the account items among a plurality of predetermined types according to the categories specified for the account items.

20. The online accounting system as claimed in claim 19, wherein the types comprise sales, purchases, expenses, and all other transactions.
